(19) United States
(12) Patent Application Publication
(10) Pub. No.: US 2024/0386241 A1
(43) Pub. Date: Nov. 21, 2024

(54) GENERATING GRAPH EMBEDDINGS ON DISTRIBUTED PROCESSORS

(71) Applicant: Google LLC, Mountain View, CA (US)

(72) Inventors: Brandon Asher Mayer, Ocala, FL (US); Bryan Thomas Perozzi, Cranford, NJ (US); Hendrik Fichtenberger, Kilchberg (CH); Anton Tsitsulin, Jersey City, NJ (US); Jonathan Jesse Halcrow, Atlanta, GA (US)

(21) Appl. No.: 18/664,164

(22) Filed: May 14, 2024

Related U.S. Application Data
(60) Provisional application No. 63/466,718, filed on May 15, 2023.

(51) Int. Cl. G06N 3/042; G06N 3/08

(52) U.S. Cl. CPC G06N 3/042; G06N 3/08

(57) ABSTRACT

A distributed computing system is configured to perform operations for embedding graphs of large scale. The system can generate node sequences from a target graph, determine training samples, and perform unsupervised learning using counts of co-occurrences between nodes to iteratively update an embedding table and learn a low-dimensional representation of the graph.

### CROSS-REFERENCE TO RELATED APPLICATIONS

This application claims the benefit of priority under 35 U.S.C. § 119 (e) to U.S. provisional application Ser. No. 63/466,718, filed May 15, 2023, the entire contents of which are incorporated by reference herein.

### BACKGROUND

This specification generally relates to graph embeddings, and more specifically to techniques for generating embeddings for potentially very large graphs (e.g., graphs containing many millions or billions of nodes) using distributed computer processing architectures.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

Graphs are data structures that represent objects and their relationships as a collection of nodes and edges, respectively. With ever increasing amounts of data being curated and modeled as graphs, there is increasing industrial and academic need to quickly analyze very large graphs such as graphs that often have billions of nodes and trillions of edge.

### SUMMARY

This specification generally describes systems, methods, devices, and related techniques for generating latent representations of graphs representing structured data using distributed processing architectures. In general, the systems and devices described in the specification can be implemented as computer programs on one or more computers in one or more locations.

In some implementations, a latent representation is generated for a graph, the graph including a set of nodes and a set of edges, each edge in the set of edges connecting a respective pair of nodes in the graph. The system obtains a plurality of graph samples, each graph sample identifying a source node from the set of nodes in the graph, a second node from the set of nodes in the graph, and a count of co-occurrences between the source node and the second node in a set of random walks initiated from the source node in the graph. The system initializes values of an embedding table for the graph, the embedding table comprising a plurality of sets of embedding parameters, each set of embedding parameters defining a respective latent representation for a different node of the graph. In each of a series of training steps, a set of worker subsystems can generate a batch of training data. The batch of training data can include a portion of the plurality of graph samples selected for use as positive training samples for the batch. The system can determine losses for the graph samples in the batch including, for each graph sample in the batch, determining a respective loss for the graph sample based on (i) a measure of similarity between current values of the respective sets of embedding parameters for the source node identified by the graph sample and the second node identified by the graph sample and (ii) the count of co-occurrences between the source node and the second node in the set of random walks initiated from the source node in the graph as identified by the graph sample. The losses can be used to update the current values of the sets of embedding parameters in the embedding table for the source nodes identified by the graph samples in the batch.

In additional implementations, a latent representation is generated for a graph, the graph including a set of nodes and a set of edges, each edge in the set of edges connecting a respective pair of nodes in the graph. The system obtains a plurality of graph samples, each graph sample identifying a source node from the set of nodes in the graph, a second node from the set of nodes in the graph, and a count of co-occurrences between the source node and the second node in a set of random walks initiated from the source node in the graph. The system initializes values of an embedding table for the graph, the embedding table comprising a plurality of sets of embedding parameters, each set of embedding parameters defining a respective latent representation for a different node of the graph. A server system maintains master values of the embedding table for the graph, including maintaining master values for the plurality of sets of embedding parameters; for each worker subsystem in a set of worker subsystems, and for each of a subset of the plurality of graph samples from the plurality of graph samples assigned to the worker subsystem: obtaining, by the worker subsystem and from the server system, the master values of the set of embedding parameters for the source node identified in the graph sample; determining, by the worker subsystem, a loss for the graph sample based on (i) a measure of similarity between the obtained master values of the respective sets of embedding parameters for the source node identified by the graph sample and the second node identified by the graph sample and (ii) the count of co-occurrences between the source node and the second node in the set of random walks initiated from the source node in the graph as identified by the graph sample; generating, by the worker subsystem, updated values for the set of embedding parameters of the source node based on the loss; and updating the master values for the set of embedding parameters for the source node at the server system with the updated values generated by the worker subsystem.

The techniques disclosed herein can realize significant advantages for embedding potentially large graphs as scale for reasons addressed further in the detailed description.

### BRIEF DESCRIPTION OF DRAWINGS

FIG. 1 illustrates the conversion of an example graph from a graph space to an embedding space.

FIG. 2 depicts a flowchart of an example process for generating a graph embedding.

FIG. 3 depicts a first distributed computing system configured to generate embeddings for potentially very large graphs according to a parameter-server model.

FIG. 4 depicts a second distributed computing system configured to generate embeddings for potentially very large graphs using tensor processing units (TPUs).

### DETAILED DESCRIPTION

This specification describes systems, methods, devices, and techniques for generating graph embeddings using unsupervised learning techniques. Graphs are data structures that are commonly used to represent a set of items and their relationships. Graphs include nodes that represent the items themselves and edges that connect pairs of nodes to model a relationship between the respective items represented by the pair of nodes connected by the edge.

To derive meaningful insights from a graph, it often useful to analyze the graph not in its original form but instead in an “embedding” space. An “embedding” is a low-dimensional representation of a graph, which is often better facilitates downstream processing for tasks such as classification, link prediction, and node clustering. Graph embeddings encode information about nodes and their arrangement in a graph in vectors that can be processed by neural networks and other machine-learning models.

Graph data naturally arises in many domains, including social, biological, and computer networks. Indeed, graphs can be employed to model the structure of webpages and other online resources, user-content interactions, including purchase and content networks. Graphs can have tremendous variation in size/scale depending on the context in which they are formed. In industrial applications, it is not uncommon for graphs to grow to billions of nodes and trillions of edges in size. Making intelligent automated decisions with such large-scale graph data sets is extremely compute and storage intensive and often renders these tasks impractical to solve on commodity hardware. This specification describes solutions to these problems including algorithms for generating graph embeddings and distributed computing architectures for generating embeddings of potentially very large graphs.

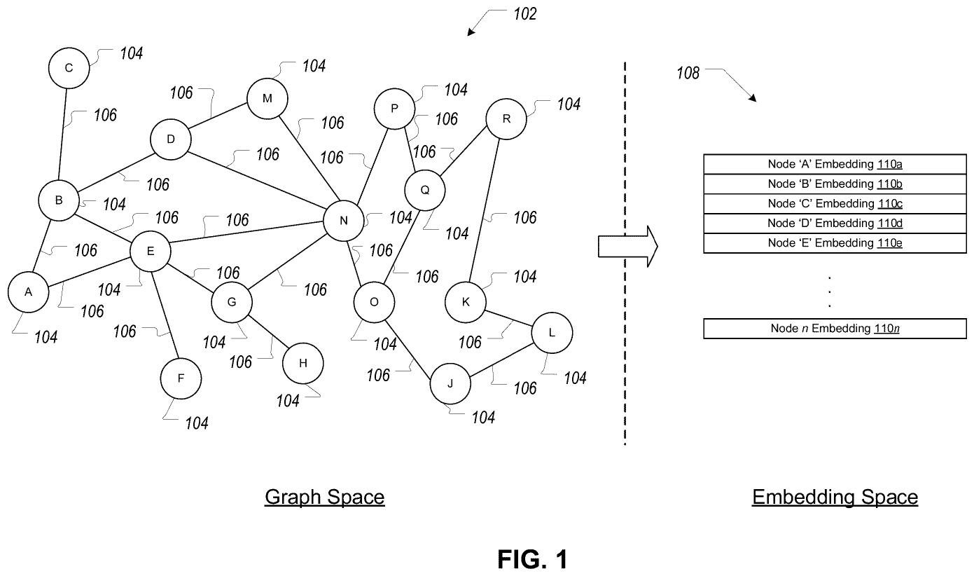

Turning to FIG. 1, an example graph 102 and its corresponding embedding 108 are shown. In this specification, the graph embedding 108 is also referred to as an embedding table. Graph 102 includes a collection of nodes/vertices 104 and edges 106. Each node 104 represents a respective object or other item in a network and each edge 106 connects a pair of nodes 106 to signify a relationship (e.g., a connection) between them. A given node 104 can be connected to one or more other nodes 104 in the graph 102 and different nodes 104 can be connected to different numbers of other nodes 104. For instance, as shown in FIG. 1, node ‘E’ connects to five other nodes 104 in the graph 102 while node ‘F’ connects to just one other node 104.

A wide range of entities and relationships can be modeled by graph 102. In some examples, graph 102 is a social graph that models a social network. In this case, nodes 104 can represent people (or social media accounts) and edges 106 can represent connections among the people or accounts in a social network. In some examples, graph 102 organizes data that characterizes user interactions with digital media items (e.g., advertisements, social media posts, images, videos, and the like), where nodes 104 represent users and/or digital media items and edges 106 represent interactions by different users with different media items. Financial networks, e-commerce transactions, computer networks, electrical grids, biological networks, and the like can all be modeled by graphs in different use cases.

As noted above, it often useful to analyze graphs not in their original form but instead in an embedding space. Embedding 108 is a low-dimensional representation of graph 102. In particular, embedding 108 is a graph embedding comprised of a collection of node embeddings 110a-n. Each node 104 in graph 102 has a respective node embedding 110, although in some cases, some nodes 104 are excluded from the graph embedding 108 (i.e., graph embedding 108 does not include respective node embeddings 110 for the excluded nodes 104).

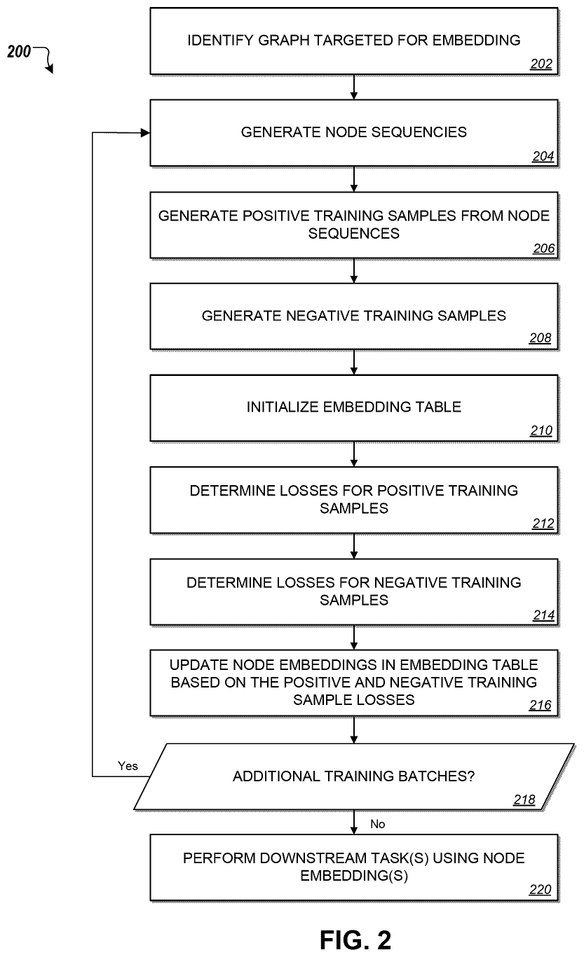

Each node embedding 110a-n comprises a vector of values (e.g., floating point numbers) that carry semantic information about its corresponding node 104 in graph 102. Such semantic information can characterize intrinsic properties of the node 104 itself (e.g., the type of node 104 and/or other attributes of the node 104) as well as relationships of the node 104 to other nodes 104 in graph 102. Node embeddings 110a-n are typically dense and low dimensional. For example, the number of parameters in each node embedding 110 (i.e., the size of the vector and hence the number of floating point numbers) may be less than or equal to 4, 8, 16, 32, 64, 128, 256, 512, or 1024 depending on the application. Techniques for generating the node embeddings 110a-n such that they carry meaning semantic information about the nodes 104 in the graph are described in further detail below with respect to FIGS. 2-4.

In this specification, the term “embedding” is used interchangeably with “latent representation.” Thus, a graph embedding can be an embedding table that includes a plurality of sets of embedding parameters, each of which defines a respective latent representation (e.g., a respective node embedding) for a different node of a graph.

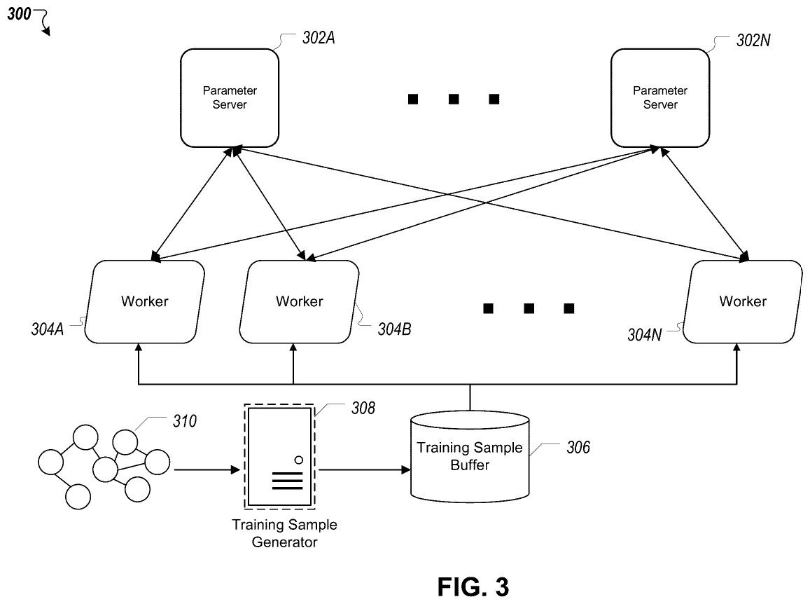

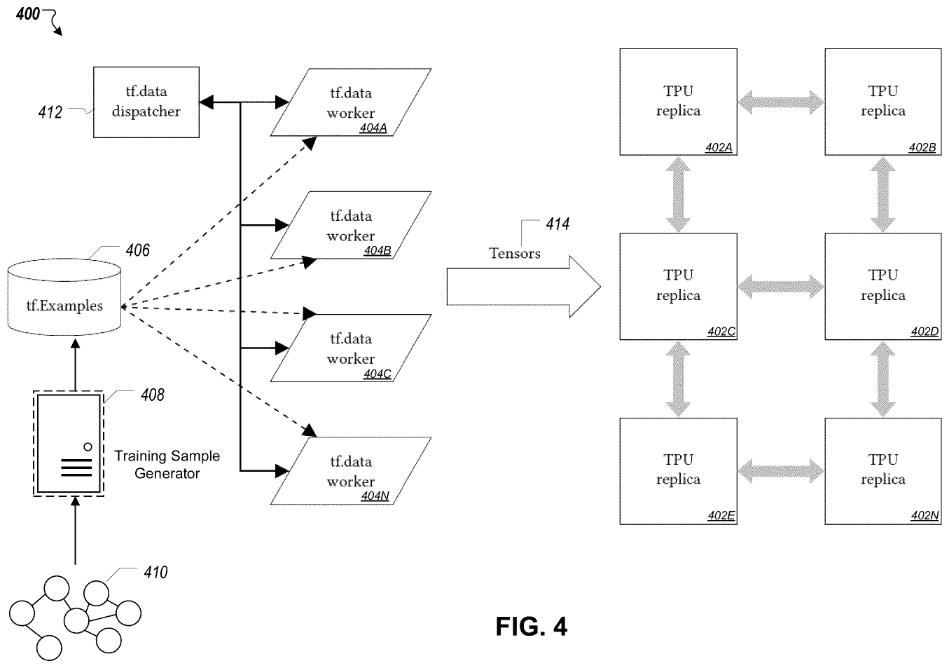

Referring to FIG. 2, a flowchart is depicted of an example process 200 for generating a graph embedding using unsupervised learning techniques. Process 200 can generally be performed to derive a graph embedding (e.g., graph embedding 108) from any suitable graph (e.g., graph 102). In some cases, the graph is very large and distributed processing techniques like those described below with respect to FIGS. 3-4 are applied to reduce the time required to generate a complete graph embedding. Process 200 can be carried out by a system of one or more computers in one or more locations.

To start, the system identifies a target graph (202). The target graph is the graph that is to be embedded and it can include many nodes (e.g., hundreds, thousands, millions, or even billions of nodes) and edges that each connect a respective pair of nodes to signify a relationship between the items represented by the nodes.

The system then generates node sequences from the target graph (204). In general, a node sequence is a set of nodes in the target graph connected by a series of edges. For example, referring to graph 102 (FIG. 1), nodes A-B-D-M and R-K-L-J are each node sequences obtained by successively traversing a series of edges that connect consecutive nodes in the respective sequences.

In some implementations, the system generates node sequences from the target graph by performing a random walk algorithm. In a random walk, a source node is selected as the starting point of the walk. A node sequence is then constructed by traversing a series of nodes starting from the source node that are connected by edges in the target graph. At each node, the next node in the sequence is selected randomly from among the set of node(s) connected to the current node. For example, in FIG. 1, the node sequence A-B-D-M can be constructed by selecting node A as the starting node. The next node in the sequence could be either node B or node E, but in this instance, node B is taken as the next node according to a random selection. Node D is then selected randomly from the set of nodes connected to node B (i.e., from among nodes C and D), and M is then randomly selected as the fourth node in the sequence based on its connection to node D. In some implementations, the random walk is performed as described in Perozzi et al., DeepWalk: Online learning, KDD 2014 at pp. 701-710, which is incorporated by reference in its entirety in this specification.

For every node that is to be embedded, the system performs at least one and typically multiple random walks from that node as a source node to generate node at least one and typically multiple node sequences with that node as the source/starting node in the sequence. The number of walks per source node and the length of the walk (and hence the length of the node sequence, i.e., the window size) can be set by default or by the user as desired.

The system generates positive training samples from the node sequences (206). A positive training sample can be a triple comprising data that identifies (i) a source node, (ii) a co-occurring node, and (iii) a co-occurrence histogram. A co-occurring node is a node that appears in at least one node sequence with the source node. In some implementations, a positive training example is created for each unique pair of source node and co-occurring node. Thus, if a given source node has twelve co-occurring nodes that appear in the node sequences generated from that source node, twelve positive training examples can be derived from the node sequences for that source node.

The co-occurrence histogram specifies the number of times the co-occurring node appeared in a random walk (node sequence) starting from the source node at each step in the random walk. For example, consider a graph with nodes (A, B, C, D, . . . ), where node sequences are generated with a walk length of 4 and where 128 walks were carried out for each source node. The positive training sample (A, C, [3, 124, 1, 0]) indicates a low probability of hopping from source node A to co-occurring node C at the first step of the walk (which occurred only 3/128 times), a high probability of reaching node C when starting from node A at the second step of the walk (which occurred 124/128 times), and low probabilities of reaching node C on either steps three or four of the walk (which occurred only once and zero times, respectively). Positive training samples can be similarly created for each of the other co-occurring nodes in the node sequences for source node A, and for each of the other source nodes.

The system can also generate negative training samples from the node sequences (208). Negative training samples generally identify non-co-occurring nodes, i.e., nodes that do not appear in the random walks or corresponding node sequences from a given source node. A negative training sample can be a double comprising data that identifies (i) a source node and (ii) a non-co-occurring node. In some implementations, the non-co-occurring node is specifically selected from a set of nodes in the graph that excludes all of the co-occurring nodes with respect to a given source node. However, this can be computationally expensive, and the same result can be approximated for large graphs by more simply selecting any random node from the graph as a non-co-occurring node. When the total number of nodes in the graph is much larger than the number of co-occurring nodes, a very high probability already exists of selecting a true non-co-occurring node in this fashion. Conversely, a very low probability already exists of selecting a co-occurring node as a non-co-occurring node in this fashion. In some implementations, at least the same number of negative training samples are generated for each source node as positive training samples. In some implementations, many more negative training samples are generated for each source node as positive training samples.

The system initializes the embedding table (i.e., initializes the graph embedding) (210). The embedding table contains a respective node embedding for each node in the target graph that is to be embedded, typically each source node. Each node embedding is a vector of floating point numbers (parameters) that, after unsupervised training, will represent semantic information about a corresponding node in the target graph. The size oof the node embedding vectors can be determined based on default criteria or set by a user as desired. Initially, the values of the node embedding vectors are set randomly. For instance, a respective random value can be determined and assigned as the initial value of each parameter in the vector for each node embedding at the start of training.

The system iteratively updates the node embeddings in the table using unsupervised learning until one or more termination criteria are met. Through unsupervised learning, node embeddings are updated based on losses computed from the positive and negative training samples. In general, the training process updates values in node embedding vectors to minimize/reduce the distance between embeddings for co-occurring nodes and to maximize/increase the distance between embeddings for non-co-occurring nodes. Training can be performed asynchronously on individual training samples or synchronously in batches.

The system determines losses for positive training samples (212). The loss term for a positive training sample is determined based on (i) a measure of similarity between the corresponding embeddings for the source node and the co-occurring node in the positive training sample and (ii) an effective edge score. The measure of similarity can be a Euclidean or cosine distance, for example. The effective edge score modulates how much the position of the embeddings should be updated based on co-occurrence counts at each step of the walk. The effective edge score is itself a function of a defined set of positive feature weights and the co-occurrence histogram from the training sample. The positive feature weights vector define the weights or relative contribution of co-occurrence counts at each step of the walk. Typical positive feature weight values are monotonically decreasing, e.g., [0.9, 0.6, 0.4, 0.2], to provide a greater contribution to co-occurring nodes at the first step of a walk or node sequence than later steps in the walk or node sequence. An effective edge score can be computed, for example, by multiplying the positive feature weight value by the co-occurrence count for each step and summing the products from each step. In this way, the loss term for the positive training sample is increased for greater distances between the embeddings for the source and co-occurring node and for higher co-occurrence counts in the histogram at step(s) in the walk that have higher positive feature weight(s).

The system determines losses for negative training samples (214). The loss term for a negative training sample is determined based on a measure of similarity between the corresponding embeddings for the source node and the non-co-occurring node in the negative training sample. The measure of similarity can be a Euclidean or cosine distance, for example. Appropriate negation and logarithms can be applied to the loss terms for both positive and negative training samples.

The system next updates node embeddings in the embedding table, e.g., by backpropagating a gradient of the loss terms for both the positive and negative training samples and adjusting current values of the parameters in the node embedding vectors (216). If batch training is performed, the system checks whether additional training batches are available or if a training termination condition has otherwise been satisfied (218). If additional batches are available, training continues and relevant operations from process 200 are repeated. If additional batches are not available or a training termination condition is otherwise satisfied, the graph embedding (e.g., the entire embedding table) or a subset thereof are provided for us in one or more downstream machine-learning tasks (220). For instance, link prediction, node identification, clustering, entity reconciliation, entity recognition, knowledge graph grounded retrieval and augmented generation are all examples of downstream machine-learning tasks that may be performed using graph embeddings.

FIG. 3 illustrates a first architecture for a distributed computing system 300 configured to generate graph embeddings, e.g., according to the process 200 of FIG. 2. System 300 leverages distributed training with commodity hardware (e.g., CPUs). Two pools of machines are provided, namely a cluster of parameter-servers 302A-N and a pool of workers 304A-N. During initialization, trainable variables such as the large embedding table are sharded across the machines in the parameter-server pool 302A-N. Workers 304A-N distribute and consume batches of positive and negative training samples from training sample buffer 306 and asynchronously fetch embedding activations (i.e., current values of the node embedding parameters) from parameter servers 302A-N, compute a forward pass and gradients and asynchronously push gradient updates to the relevant activations back to the parameter servers 302A-N. There is no locking or imposed order of activation look-ups or updates. This allows for increased throughput, albeit at the cost of potentially conflicting gradient updates. Training sample generator 308 can perform random walks to generate node sequences and training samples from graph 310, which are provided to buffer 306. FIG. 4 illustrates a second architecture for a distributed computing system 400 configured to generate graph embeddings, e.g., according to the process 200 of FIG. 2. FIG. 4 visualizes the system design of distributed training using tensor processing units (TPUs) after the sampling procedure is complete. The replication strategy used for TPUs in conjunction with their high FLOPS per second involves generating very large batches of training examples for every step. The bottleneck in this system is thus rarely the embedding lookup or model tuning but the input pipeline to generate the large batch size at every step. In some implementations, a large embedding table is efficiently shaded over the TPU HBM using TensorFlow TPUEmbedding layer. A cluster of machines 404A-N that read, parse and randomly sample the input data is leveraged to avoid an input bottleneck. File shards of the positive (and optionally negative) training samples are distributed from buffer 406 over the workers 404A-N in a cluster dedicated to generating input data. The workers 404A-N independently deserialize the co-occurrence input data and optionally augment the source_id and destination_id pairs with negative samples, replicating source_id and randomly sampling additional destination_id node IDs uniformly from the embedding vocabulary. The input cluster 404A-N then streams the resulting training tensors 414 to the TPU system of TPUs 402A-N which de-duplicates and gathers the relevant embedding activations for the batch and distributes the computational work of computing the forward pass and gradient to the TPU replicas which are then aggregated and used to update the embedding table. The TPUs 402A-N can include one or more matrix multiplication units optimized for performing matrix multiplication operations, while the workers 404A-N are not similarly configured with matrix multiplication units.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a standalone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method for generating a latent representation of a graph, the graph comprising a set of nodes and a set of edges, each edge in the set of edges connecting a respective pair of nodes in the graph, the method comprising:
obtaining a plurality of graph samples, each graph sample identifying a source node from the set of nodes in the graph, a second node from the set of nodes in the graph, and a count of co-occurrences between the source node and the second node in a set of random walks initiated from the source node in the graph;
initializing values of an embedding table for the graph, the embedding table comprising a plurality of sets of embedding parameters, each set of embedding parameters defining a respective latent representation for a different node of the graph;
for each of a series of training steps:
generating, by a set of worker subsystems, a batch of training data, the batch of training data comprising a portion of the plurality of graph samples selected for use as positive training samples for the batch;
determining losses for the graph samples in the batch including, for each graph sample in the batch, determining a respective loss for the graph sample based on (i) a measure of similarity between current values of the respective sets of embedding parameters for the source node identified by the graph sample and the second node identified by the graph sample and (ii) the count of co-occurrences between the source node and the second node in the set of random walks initiated from the source node in the graph as identified by the graph sample; and
using the losses to update the current values of the sets of embedding parameters in the embedding table for the source nodes identified by the graph samples in the batch.

2. The method of claim 1, comprising performing a respective set of random walks for each source node in the graph, wherein performing each random walk comprises making a defined number of hops to follow a succession of nodes in the graph starting from the source node, wherein the destination for each hop is selected randomly from among the set of nodes directly connected by a respective edge to the node where the walk is currently located.

3. The method of claim 1, comprising performing a defined number of random walks initiated from each source node in the graph, each random walk limited to a defined number hops from the respective source node for that random walk.

4. The method of claim 1, wherein the set of tensor processing subsystems include one or more matrix multiplication units optimized for performing matrix multiplication operations, wherein the set of worker subsystems are without matrix multiplication units.

5. The method of claim 4, wherein the set of worker subsystems are implemented on a collection of central processing units (CPUs), a collection of graphics processing units (GPUs), or a collection of CPUs and GPUs.

6. The method of claim 1, further comprising de-duplicating training inputs in the batch of training data.

7. The method of claim 1, wherein a total number of nodes in the graph is at least a million, at least ten million, at least one hundred million, at least a billion, at least ten billion, or at least one hundred billion.

8. The method of claim 7, wherein each node in the graph is represented in the embedding table.

9. The method of claim 7, wherein only a subset of nodes in the graph are represented in the embedding table.

10. The method of claim 1, further comprising using trained values for the set of embedding parameters of nodes in the graph to model at least a portion of the graph in a downstream graph analysis process.

11. The method of claim 1, further comprising, for each training step in the series of training steps, generating, by the set of worker subsystems or the set of tensor processing subsystems, a set of negative training samples for the batch of training data, each negative training sample identifying a source node in the graph and a randomly selected second node in the graph.

12. The method of claim 11, wherein generating the set of negative training samples for the batch of training data comprises, for each positive training sample in the batch, generating n negative training samples that identify the same source node as the positive training sample but that identifies a respective second node that was not identified from the result of a random walk initiated at the source node, wherein n>1.

13. The method of claim 11, further comprising:
determining a respective loss for each negative training sample in the batch based on a measure of similarity between current values of the respective sets of embedding parameters for the source node identified by the negative training sample and the second node identified by the training sample; and
using the respective losses for the negative training samples in the batch to update the current values of the sets of embedding parameters for the source nodes identified by the negative training samples in the batch.

14. The method of claim 1, comprising:
for each source node in the graph, accumulating losses generated from positive and negative training samples for the source node;
determining a gradient of the accumulated losses; and
propagating the gradient of the accumulated losses back through a neural network that includes the embedding table as an embedding layer and an output layer.

15. The method of claim 1, wherein the measure of similarity between current values of the respective sets of embedding parameters for the source node identified by the graph sample and the second node identified by the graph sample is a cosine distance or a Euclidean distance.

16. The method of claim 1, wherein determining the respective loss for the graph sample comprises weighting the measure of similarity by the count of co-occurrences.

17. A method for generating a latent representation of a graph, the graph comprising a set of nodes and a set of edges, each edge in the set of edges connecting a respective pair of nodes in the graph, the method comprising:
obtaining a plurality of graph samples, each graph sample identifying a source node from the set of nodes in the graph, a second node from the set of nodes in the graph, and a count of co-occurrences between the source node and the second node in a set of random walks initiated from the source node in the graph;
initializing master values of an embedding table for the graph, the embedding table comprising a plurality of sets of embedding parameters, each set of embedding parameters defining a respective latent representation for a different node of the graph;
maintaining, by a server system, the master values of the embedding table for the graph, including maintaining master values for the plurality of sets of embedding parameters;
for each worker subsystem in a set of worker subsystems, and for each of a subset of the plurality of graph samples from the plurality of graph samples assigned to the worker subsystem:
obtaining, by the worker subsystem and from the server system, the master values of the set of embedding parameters for the source node identified in the graph sample;
determining, by the worker subsystem, a loss for the graph sample based on (i) a measure of similarity between the obtained master values of the respective sets of embedding parameters for the source node identified by the graph sample and the second node identified by the graph sample and (ii) the count of co-occurrences between the source node and the second node in the set of random walks initiated from the source node in the graph as identified by the graph sample;
generating, by the worker subsystem, updated values for the set of embedding parameters of the source node based on the loss; and
updating the master values for the set of embedding parameters for the source node at the server system with the updated values generated by the worker subsystem.

18. The method of claim 17, wherein the server system is configured to leave the master values for the set of embedding parameters for each node unlocked while a given worker subsystem works on updating the master values for the node.

19. The method of claim 17, wherein the plurality of graph samples are sharded across the set of worker subsystems.

20. A system, comprising:
one or more processors; and
one or more non-transitory computer-readable media having instructions stored thereon that, when executed by the one or more processors, cause performance of operations comprising:
obtaining a plurality of graph samples, each graph sample identifying a source node from the set of nodes in the graph, a second node from the set of nodes in the graph, and a count of co-occurrences between the source node and the second node in a set of random walks initiated from the source node in the graph;
initializing values of an embedding table for the graph, the embedding table comprising a plurality of sets of embedding parameters, each set of embedding parameters defining a respective latent representation for a different node of the graph;
for each of a series of training steps:
generating, by a set of worker subsystems, a batch of training data, the batch of training data comprising a portion of the plurality of graph samples selected for use as positive training samples for the batch;
determining losses for the graph samples in the batch including, for each graph sample in the batch, determining a respective loss for the graph sample based on (i) a measure of similarity between current values of the respective sets of embedding parameters for the source node identified by the graph sample and the second node identified by the graph sample and (ii) the count of co-occurrences between the source node and the second node in the set of random walks initiated from the source node in the graph as identified by the graph sample; and
using the losses to update the current values of the sets of embedding parameters in the embedding table for the source nodes identified by the graph samples in the batch.
